(19) United States
(12) Patent Application Publication
(10) Pub. No.: US 2001/0014873 A1
(43) Pub. Date: Aug. 16, 2001

(54) SYSTEM FOR ADMINISTERING A GUARANTEED BENEFIT ACCOUNT

(76) Inventors: GARY E. HENDERSON, FAIRPORT, NY (US); STEVEN P GREINER, CANANDAIGUA, NY (US); JEFFREY S. COONS, ROCHESTER, NY (US)

Correspondence Address: SIMPSON SIMPSON & SNYDER. LLP, 5555 MAIN STREET, WILLIAMSVILLE, NY, 14221-5406, US

(21) Appl. No.: 09/239,074

(22) Filed: Jan. 27, 1999

(51) Int. Cl. G06F 17/60

(52) U.S. Cl. 705/35; 705/39

(57) ABSTRACT

A system for administering a guaranteed benefit account held by an individual, including a computer having a central processing unit for processing data, storage means for storing input data related to compensation levels of an individual account holder, contribution patterns of the individual account holder, and time periods from opening of the account until disbursement of account funds for the individual account holder, and, a first arithmetic logic circuit configured to calculate plan disbursements as a guaranteed percentage of individual account holder compensation levels.

This patent includes a microfiche appendix containing 1 microfiche having 33 frames. The microfiche is intended to be a part of the written description pursuant to 35 U.S.C. 112.

### FIELD OF THE INVENTION

This invention relates generally to benefit plans, more particularly to retirement plans, and, even more specifically, to a new type of defined benefit account and defined benefit plan.

### BACKGROUND OF THE INVENTION

As longevity among the general population increases, so does the need for adequate retirement funding. To maintain a suitable standard of living in retirement, experts estimate that an individual will need 70-90% of pre-retirement income. Income for retirement will come from a combination of personal assets, including savings and other investment vehicles, Social Security benefits, and employee or self-employed retirement plans. The main source of retirement income most likely will come from the latter described retirement plans. As such, the type of retirement plan offered by an employer may be of significant importance to a potential employee.

Retirement plans for company employees have traditionally been of two types: defined benefit plans (DB) and defined contribution plans (DC). Each type of plan has advantages and disadvantages, from the perspectives of both employer and employee.

### Defined Benefit Plans (DB)

Defined benefit plans guarantee a fixed, life-time income at retirement. The amount of the benefit is generally determined by how long the employee was employed, and how much the employee earned during the employment period. The guaranteed benefit may be computed as a flat dollar amount, a flat percentage of earnings, a flat amount per year of service, or a percentage of earnings per year of service. Under a defined benefit plan, an employee typically does not pay into the plan, with the employer funding the entire plan. To an employee, this type of plan offers a high level of security, as the employee is guaranteed a specific level of income during his or her retirement years. Since the formulas for determining that guaranteed level of income most often factor in an employee's pre-retirement compensation with the company, each employee is more likely to have a standard of living in retirement commensurate with his or her standard of living while working. The employer bears the investment risk to ensure that a sufficient amount is in the plan to fund the guaranteed benefit at retirement for the employee. Accordingly, even if the plan investments lose value, the employer is responsible for the employee's guaranteed benefit at retirement. The employer must also carry the plan on its company balance sheet, setting forth the value of the plan as an asset, and the related benefit responsibilities as a liability.

From the employer's perspective, a defined benefit plan has at least two positives. First, DB plans can be a valuable tool to attract and retain employees, as these plans are employer funded and offer a high level of retirement security. Second, if an employer has a keen sense of obligation to its employees, DB plans are an important vehicle to ensure retirement security—i.e., a standard of living in retirement commensurate with the standard of living before retirement. There are several negatives, however, for the employer. These plans are typically employer-funded rather than employee-contributing. The employer bears all of the investment risk to grow the plan enough to satisfy the retirement income guarantee to each employee. If the investment return falls short of assumptions, the employer has to contribute more money. The costs of DB plan administration and compliance have been rising over a number of years. These negatives are why many DB plans have been terminated by companies and few new DB plans are being formed. Most companies now offer a defined contribution plan, such as a 401(k) plan, as the sole retirement vehicle for employees. For a variety of reasons, as will be discussed in the next section, this has eroded the overall level of retirement security nationally and, as many employees come up financially “short” at retirement, the burden on society will significantly increase.

From the employee's perspective, there are three major advantages of a defined benefit plan. It is employer funded. The employer takes the investment risk. A defined benefit plan has at least two disadvantages. First, it may take a number of years (five to ten, for example) to become vested in a company's DB plan. If an employee leaves a company before he is vested, he forfeits any benefit under the DB plan. As opposed to one or two generations ago when most people worked at one company their entire career, the average person now in the United States will change companies a number of times during his or her career. It is very possible that a person could reach retirement age with no retirement benefit, even if each individual company that person worked for during his career had a DB plan in place. Second, the employee cannot add his or her own contributions to a DB plan. Some employees may want a higher level of guaranteed income in retirement than what the employer contributions are funding if the employee believes another source of retirement income such as Social Security will be less than expected at retirement time.

### Defined Contribution Plans (DC)

In contrast, defined contribution plans do not offer a guaranteed level of life-time income at retirement. In essence, the current contribution is defined, not the future benefit. With a 401(k) plan, the most popular type of defined contribution plan, the current contribution or “deferral” comes from the employee and is expressed as a percentage of current employee compensation. Often, 401(k) plans will have employer contributions as well, such as a company match, expressed as a percentage of an employee's deferrals, or a profit sharing contribution, based upon a formula tied into company profits for the year. Another type of defined contribution plan, a money purchase pension plan, has a current contribution by the employer expressed as a fixed percentage of an employee's current compensation. With each of these plans, no one knows what the future benefit will be, which is based upon investment return, or whether that benefit will be enough to ensure a standard of living in retirement commensurate with the pre-retirement standard of living. Even if an employee's pre-retirement wages rise in line with an increasing inflation rate, if the post-retirement benefit is not tied into the pre-retirement wage level, a person may have to either dramatically reduce his or her standard of living at retirement or continue working and perhaps not retire at all.

A 401(k) plan is a type of defined contribution plan. Most 401(k) plans are “employee-directed” in terms of investment. Each employee will choose from a menu of investment options and create his or her own investment mix for their account. Some defined contribution plans are “sponsor-directed” in terms of investment. The company sponsoring the plan simply invests the money in a single investment pool—employees have no choice. A company does not carry a defined contribution retirement plan as an asset and liability on its balance sheet. Within a defined contribution plan, each employee has his or her own retirement account. Investment earnings, contributions, withdrawals, and other transactions are tracked for each employee by a plan record keeper, resulting in a periodic, custom account statement for each employee.

From the employer's perspective, defined contribution plans have several advantages. First, there is no investment risk. While the employer desires that the investment return be good, whether sponsor-directed or employee-directed, the employer does not bear the risk of having to made additional contributions if the investment return is poor. That is because there is no guarantee as to the level of future benefits. Second, there are lower administrative and compliance costs. Third, there are lower levels of employer contributions. The sum of a company match and profit sharing contribution is frequently lower than what an employer contributes to fund a DB plan. Fourth, employees often appreciate 401(k) plans over DB plans, not because 401(k) plans are better than DB plans for the employee, but because 401(k) plans are simply more understandable to most employees. There are disadvantages associated with defined contribution plans, however, from the employer's perspective. The major negative is that many plan sponsors quietly believe that a substantial number of employees will fall short of retirement income needs for two reasons. Employees will not save enough during the working years, primarily from a lack of education as to what is necessary. Also, employees will make poor investment decisions along the way with their 401(k) monies. Switching back and forth between investment options at the wrong time, even if it is infrequent switching that happens during critical periods, will dramatically and negatively affect an employee's 401(k) account and associated retirement benefit.

All employees like the vesting schedule for defined contribution plans—immediate vesting for employee contributions and fairly short-term vesting for employer contributions. As a result of the attractive vesting, defined contribution plans are very portable. An employee accrues a retirement benefit/account quickly and can take those monies with him or her when they leave the company. The employee can either spend the money, with income tax and certain excise taxes applying, put the money in a tax-deferred IRA Rollover account, or transfer the money to the 401(k) plan of the employee's new employer, if that employer allows such transfers. Another positive for employees is that many defined contribution plans allow the employee to take a plan loan or hardship withdrawal if he or she needs to access their monies prior to retirement. To evaluate the employee's perspective further, it is necessary to differentiate between two different types of employees. The minority group of “do-it-yourselfers” prefer the investment choices and investment freedom of a 401(k) plan. Most employees, however, know that they do not have the time and/or expertise to make the right decisions to satisfy their retirement goals. They are worried that they won't save enough, won't invest the monies properly, or that a rising inflation rate close to retirement, even if pre-retirement compensation rises commensurately, will leave the post-retirement level of income inadequate relative to the pre-retirement standard of living.

### Insurance and Annuity Products

Annuities are often used in group retirement plans or accounts because they offer several features that an ordinary investment account or mutual fund does not. They may be one of many different kinds, for instance, traditional fixed annuity, interest-indexed or equity-indexed annuity, bailout, certificate, market value adjusted, bonus rate, two tiered or a variable annuity, are just some of the varieties available. There are a great diversity of options, surrender charge schedules and settlement options but most annuities offer some common features and benefits which are: tax deferral, ordinary income treatment, income tax exclusion (ratio) availability on withdrawals, 10 percent pre-59½ withdraw penalty, no stepped up cost basis at the death of annuitant, probate avoidance, a death benefit and lifetime income availability through the annuitization or settlement options. Annuities also may be IRS qualified and used in a 401(k) rollover situation or non-qualified. Annuities are essentially a contract between the owner and the insurer.

Annuities may have different payout options. Traditionally, the annuitization option, whereby the owner gives up the right to the lump sum and acquires lifetime income through some actuarially defined life expectancy has been the most popular method of liquidation. This method provides a series of guaranteed periodic income (monthly, quarterly, semi-annually or annually) to the annuitant as long as he live. When the annuitant or owner dies, all payments stop. The guarantee is a dollar amount, dependent upon the life expectancy and investment return the insurer believes he can guarantee and achieve. Once a payout selection is made and payments commence, it must continue for the life of the annuitant and is irrevocable. However, there are many variations of this payout method, each having some actuarial equivalent representation or mathematical transformation. These include straight life, joint survivor, joint survivor period certain, period certain (or term certain) joint life and variable annuitization just to name a few.

They are given by actuarial formulae and are determined typically by just three factors, assumed investment performance, one or more life expectancies or joint life expectancies and the annuity's account value. It's important to remember that the actuarial equations utilized to express or calculate these income streams are statistical in nature and are dependent upon assumptions of interest rates and mortality. Thus, using the annuity account value, one can calculate each or any of these payout options and vice versa. So for example, one can calculate the straight life annuity payment and joint life annuity payment and lump sum equivalence, and go back in forth between them with their equivalent formulas. Differing insurers may use different investment returns and actuarial tables, however, the crux of their guarantee is made in a basic dollar amount per period (month, quarterly, etc.) and is never expressed as a percent of compensation.

One may also make withdrawals systematically. This is an alternative to annuitization in that access to the lump sum is maintained and withdrawals commence merely as periodic distributions. The advantages are that they may be increased, decreased, discontinued or changed randomly. Any monies that are in a contract holder's account at the time of death are available to the beneficiaries. None of the monies are forfeited to the insurer as in annuitization. For systematic withdrawals there is no guarantee made on the withdrawal, because the amount is typically expressed as a percentage of the account value which may be guaranteed and if not, as in a variable annuity, has only a guaranteed death benefit. Thus, as in DC plans, individual account annuities do not express or make a guarantee in the form of compensation percentages either.

In sum, because of the advantages and disadvantages associated with both DB and DC types of plans, and the inadequacy of current insurance and annuity products, there is a need for a solution that offers the advantages of both a defined benefit and defined contribution plan.

### SUMMARY OF THE INVENTION

The present invention comprises a system for administering a guaranteed benefit account, including a computer including a central processing unit for processing data, storage means for storing input data related to compensation levels of plan participants, contribution patterns of plan participants, and time periods from entry into the account until disbursement of funds for each account participant, and, a first arithmetic logic circuit configured to calculate account disbursements as a guaranteed percentage of individual account participant compensation levels.

A general object of the invention is to provide a new type of benefit account that offers the advantages of both a defined benefit and defined contribution plan. An ideal solution is a single new account that offers advantages of both.

Another object of the invention is to provide a new type of benefit plan that includes the above-described account.

These and other objects, features and advantages of the present invention will become readily apparent to those having ordinary skill in the art upon a reading of the detailed description of the invention in view of the drawings and appended claims.

### BRIEF DESCRIPTION OF THE DRAWINGS

FIG. 1 is a representation of the compensation of a 30 year old, as a function of time, expressed as a percent of his age 65 total compensation. The lower curve was calculated using the standard wage inflation equation (1), while the upper curve was made using equation (2).

FIG. 2 is a plot of the account balances for the four examples. It shows that examples 1 and 3 have positive cash balances for the duration of the withdrawal during retirement, while examples 2 and 4 indicate an asset depletion schedule is being followed if the participant lives too long. In actuality, assets would not be assigned to individual participants but would probably be pooled to provide investment economies of scale and necessary liquidity.

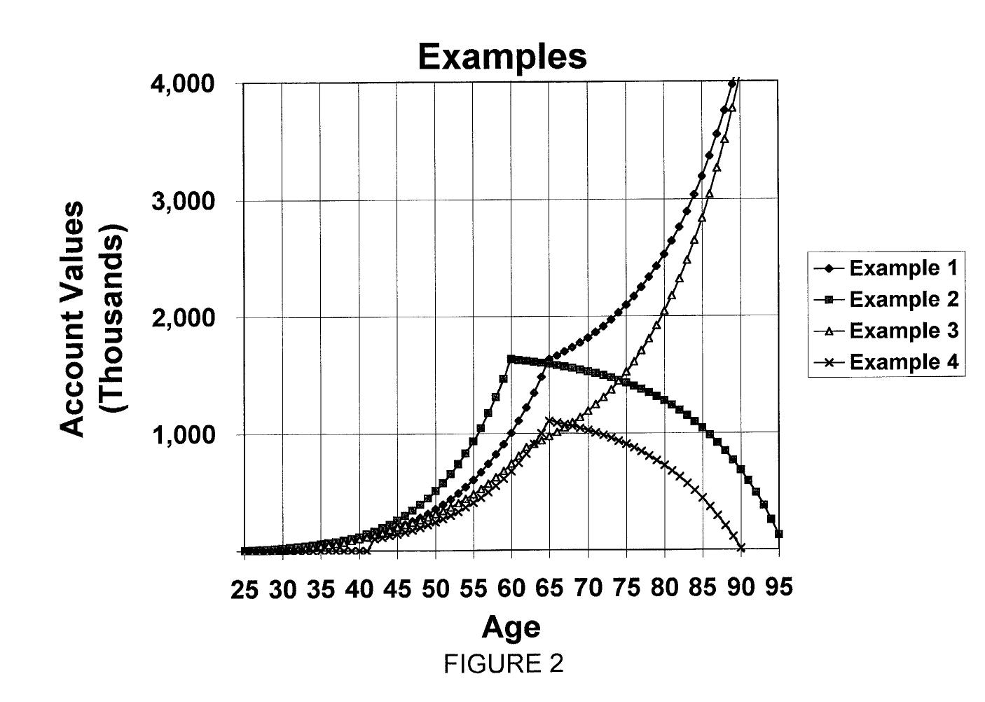

FIG. 3, is a block diagram of the computer architecture of the present invention.

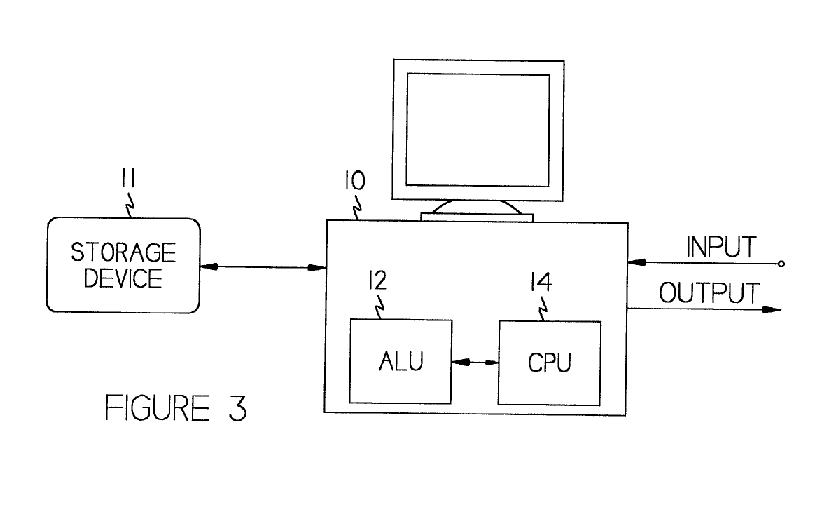

### DETAILED DESCRIPTION OF THE PREFERRED EMBODIMENT

The present invention comprises a new guaranteed benefit account which has features similar to a defined contribution plan, but includes a guaranteed disbursement benefit. In a preferred embodiment, we disclose a new guaranteed benefit account although the account can be part of a new guaranteed benefit plan. Also, although the account is described as a retirement account, the claims are not intended to be so limited. Several features differentiate the guaranteed benefit account from a defined benefit plan and defined contribution plan. First, unlike a defined benefit plan, the guaranteed benefit account can accommodate employer and employee contributions. Second, unlike a defined contribution plan, the guaranteed benefit account provides a future benefit which is guaranteed. Third, unlike a defined contribution plan, the guaranteed benefit account provides a guaranteed future benefit which is computed as a percentage of pre-retirement income. Fourth, unlike a defined benefit plan, the guaranteed benefit account provides ongoing standard of living protection. With a defined benefit plan, the value of a person's future benefit is “frozen” when that person leaves a company. It does not grow any further and, most important, the future benefit is based upon a person's compensation level with that specific company during his or her time of employment with that company. The guaranteed benefit of the guaranteed benefit account factors in a person's pre-retirement income level irrespective of the number of employers or whether each of those employers had a defined benefit plan in place. Therefore, the guaranteed disbursement benefit is expressed, not as a percentage of the employee's pre-retirement income with a particular company for a particular period of time but is expressed as a percentage of that person's pre-retirement income—even if that income was earned with multiple employers. In this way, the guaranteed benefit account achieves true portability and ensures that a person's post-retirement income and standard of living will more closely resemble what that person enjoyed pre-retirement. Each employer is the primary guarantor of the benefits in a defined benefit plan. Unlike a defined benefit plan, the primary guarantor for the guaranteed benefit account is an entity other than the employer. Structuring the guaranteed benefit account in this manner is critical to achieving the true portability referred to above.

Based upon the pattern and contributions into the guaranteed benefit account at any point in time, the individual is guaranteed a specific future benefit at retirement, expressed as a percentage of pre-retirement income. The employee may choose a range of guaranteed options from a “floor” to the “ceiling”. The floor option will guarantee the individual a certain percentage of pre-retirement income, with the individual also eligible for some portion of the investment earnings in excess of what was required to fund that guarantee. The ceiling option will guarantee the individual a higher percentage of pre-retirement income, with the individual ineligible to receive any portion of the investment earnings in excess of what was required to fund that guarantee. An individual may choose to purchase a guarantee anywhere between the “floor” and “ceiling” limits.

### Definitions

In the detailed description which follows, the following definitions apply:

Account: any accounting of an individual's monies or benefits, whether or not such monies or benefits are independent of, or part of, a plan.

Account Holder: the individual whose monies or benefits form the account.

Administering: the managing, directing, overseeing or general maintenance of a plan.

Annuitization: this is the usual method of liquidation for an annuity, where the participant gives up the right to the principal and begins a guaranteed income stream. Thus, the contract is converted from an annuity into a periodic cash flow. This method of liquidation used to be irrevocable, but more recently, some insurers have created a reversal option where once annuitization has begun, the present value of any or a portion of the remaining income stream may be taken as lump sum and the contract terminated.

Arithmetic logic circuit: refers to a computer program or set of instructions or code which cause a computer or microprocessor to function.

Compensation: refers to salary, bonus, commission and/or other income, individually or in combination, made available for contributions to the account.

Contribution patterns: the history or future projection of contributions into a plan, these may be in currency units (Dollars, Deutsche Marks, etc.) or percent of compensation wherein a contribution is an amount of compensation deferral set aside for placement into a plan.

Disbursements: one or more discrete withdrawals from an account.

First arithmetic logic circuit: a computer program which implements a method wherein disbursements are calculated as a guaranteed percentage of compensation.

Guarantee (Guaranty, Guaranteed): refers to a warranty, pledge, voucher, endorsement, bond or promise and securement of a certain replacement of compensation to an account holder by an insurer, plan sponsor or other entity.

Life expectancy: an estimate of a future age to which a person has a 50% probability of achieving as measured from that person's present age.

Plan: any detailed scheme, program or method worked out beforehand for the accomplishment of a financial goal, including but not limited to tax-qualified or non-qualified benefit and/or retirement plans.

Second arithmetic logic circuit: a computer program which implements a method wherein assets and liabilities of an account are calculated based upon certain user definable assumptions.

Sponsor: a company, corporation, individual, or other entity who supports, backs or advocates a plan and who has the authority to put such a plan into place.

Wage equation, wage function or wage curve: an estimate of future or historical compensation which describes how it changes over time, usually expressed in some analytical, mathematical form but could also be expressed numerically or in any other suitable form.

Wage inflation: an estimate of what future compensation increases or decreases (deflation) for an account holder will be, expressed as a percentage of current compensation of the historical increase or decrease expressed as a percentage of compensation or a parameter used in some mathematical or numerical embodiment to calculate or express compensation over time, (in the description that follows, then, the term “inflation” is used to encompass both “inflation” and “deflation”).

In the appended claims, certain assumptions made in implementation of the system are “user definable”; these assumptions are defined as follows:

Disability tables: a probability table which associates a probability of an account holder becoming totally disabled as a function of age or years or participation.

Disbursement age: the age at which disbursement from an account to an account holder begins.

Early retirement (disbursement) tables: a probability table which associates a probability of an account holder beginning disbursement from an account as a function of age or years of participation.

Expected investment return: the expected investment performance used to administer the account.

Guaranteed investment return: the investment performance used to make a guarantee to an account holder.

Mortality tables: a probability table which associates a probability of an account holder dying as a function of age or years of participation, e.g., 83 GAM tables.

Retirement age: the age at which an account holder discontinues employment whereby a percentage of compensation is no longer available for contribution into an account.

Turnover tables: a probability table which associates a probability of an account holder leaving an account as a function of age or years of participation.

Wage equation, wage function or wage curve: either an estimate of future or historical compensation which describes how it changes over time. Usually expressed in some analytical mathematical form but could also be expressed numerically or in any suitable form.

### Account Balance—Vested Benefit

A) Equations for account balances.

The calculation of an account holder's compensation at retirement, is based upon only three “intrinsic” criteria. These are:

| | |
|---|---|
| 1) | Initial compensation; |
| 2) | Percent of contributions until disbursement; |
| 3) | Years until disbursement; |

The derivation proceeds as follows. Final compensation is inflated at some rate (assumed in this description to be 5%) and is given by a standard wage equation formula:

F_{c}=I_{c}(1+i_{c})ⁿ⁻¹ Eq. (1)

In this equation “F_{c}” is the final compensation, “I_{c}” is the initial compensation, “i_{c}” is the compensation inflation rate (i.e., 5%) and “n” is the number of years until retirement. Although this is the equation used for all of the derivations used to implement the invention, it is important to know that compensation scales may and do follow other paths and sometimes are discontinuous. That is, there are steps in compensation increases and, sometimes with job changes, these compensation steps are significant. Conversely, there may be compensation decreases too.

One difficulty with the standard wage equation formula given above is that it presumes larger absolute increases as one gets closer to retirement. Also its second derivative is always positive (concavity), which means that absolute compensation growth is always accelerating. One may have compensation always increasing but with a negative second derivative (convexity) as well. Which implies that large compensation gains occur earlier in one's career rather than later.

A formula to use in that case is given by:

F_{c}=I_{c}(1+i_{c1})^{r-y}[1−(1+i_{c2})^{(-x-y-1)}] Eq. (2)

Where “r” is retirement age, “y” is entry age, “x” is current age and the two compensation inflation parameters, i_{c1} and i_{c2} are related via the following equation:

$${i}_{c2} = \frac{1}{{( 1 + {i}_{c1} )}^{ r - y} - 1 )} \qquad \text{Eq. (3)}$$

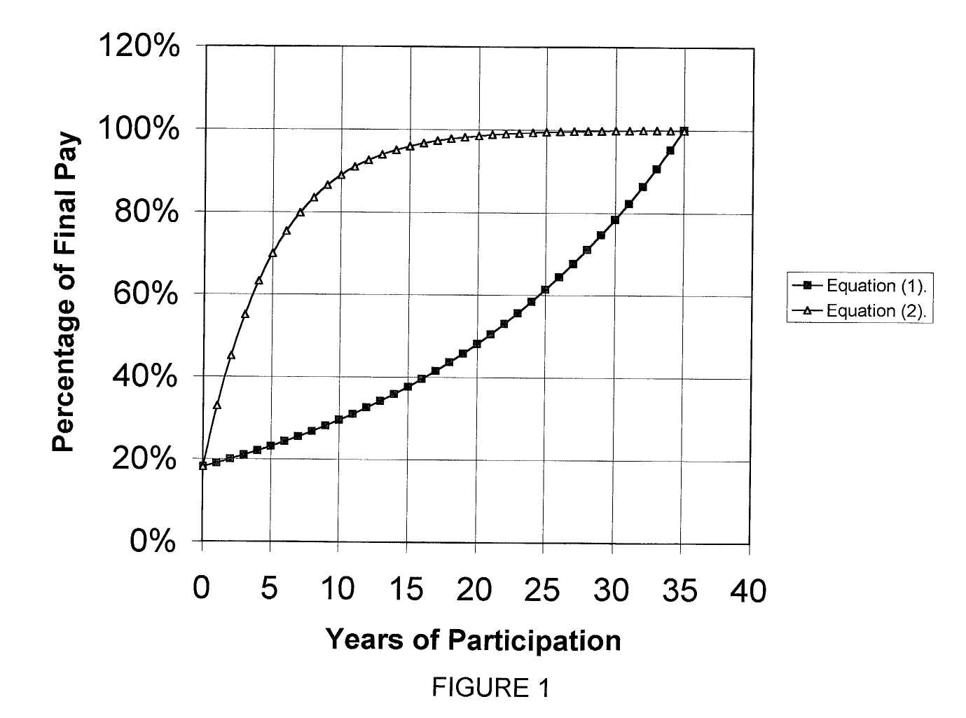

Employees on the path defined by this Equation 2 would add more dollars earlier for the same target benefit, because their salaries will increase sooner in their careers than with the standard wage equation. The graph shown in FIG. 1 illustrates this point.

Adverting to FIG. 1, both curves A and B are calculated starting with a 25 year old earning $30,000 per year with a disbursement age of 60. The curves have the same starting and ending points but reach the endpoint via different paths. Lower curve B was created using the standard wage equation (Equation 1), while upper curve A was made with Equation 2. Notice the concavity and convexity for the two compensation paths throughout the employee's career. Curve B illustrates slower growth early on, with a general acceleration of compensation as the participant ages. Thus, for constant percent compensation deferrals into a savings plan, the employee on upper curve A will obviously save more during his working years than the employee on lower curve B, due to more dollar additions saved earlier in his career, with concomitant greater investment time value for growth on his side. In practice, employees' compensation increases probably fall between these two extremes, but the present invention accommodates both, even though the present invention can promise a larger guarantee for the employee whose compensation is represented by Curve A. A linear combination of the two equations will provide something in between these two extremes where the coefficients in the linear expansion can be chosen to provide a given compensation path.

The equation for compounded investing is similar to the wage equations in that a power series is used to calculate the final account value. In the case where the amount added each year is constant, (constant dollar additions) the final account value is given by:

$${\sum }_{x = 0}^{n - 1} {{C}_{x} ( 1 + {i}_{a} )}^{x} = {F}_{A} ≡ \frac{{C}_{c}}{{i}_{a}} [ {( 1 - {i}_{a} )}^{n} - 1 ] \qquad \text{Eq. (4)}$$

Here, “Fₐ” is the final retirement account size with an investment return of “iₐ”, “Cₓ” is the constant dollar addition year over year, “C_{c}” is the constant dollar addition when all the Cₓs are identical, “n” is the number of years until retirement, while “x” is a dummy variable used in the summation over the years. If the dollar contributions remain constant over the employment of the participant, (i.e., year to year contributions are the same dollar amount, meaning all the Cs are identical) the expansion of the summation will converge to the form shown on the right side of the equality in this equation. If differing dollar contributions each year occur, the summation must remain and the left-hand side equation must be used.

Sometimes the contributions that an employee chooses will change each year. For instance, an employee might choose to defer a constant percentage of compensation rather than constant dollars. Then, because his compensation increases, his contributions will increase each year. Under these conditions, the final account formula becomes:

$${F}_{a} = {\sum }_{x = 0}^{n - 1} {{C}_{x} ( 1 + {i}_{a} )}^{n - 1 - x} where \\ {C}_{x} = \% deferral {{I}_{c} ( 1 + {i}_{c} )}^{x} \qquad \text{Eq. (5)}$$

In this formula, “Cₓ” is the dollar contribution for year “x”, “C₀”, for instance, is the percent compensation deferral for year 1, “C₁” is the percent compensation deferral for year 2 and so on. Combining all these terms gives us:

$${F}_{a} = {\sum }_{x = 0}^{n - 1} \% deferral {{I}_{c} ( 1 + {i}_{c} )}^{x} {( 1 + {i}_{a} )}^{n - 1 - x} \qquad \text{Eq. (6)}$$

Now if one expands the summation, possible only if deferral percentages do not vary year to year, and looks for convergence of the series, one arrives at the following formula (after rearrangement):

$${F}_{a} = \frac{\% deferral {{I}_{c} ( 1 + {i}_{a} )}^{n} }{( {i}_{c} - {i}_{a} )} [ {( \frac{( 1 + {i}_{c} )}{( 1 + {i}_{a} )} )}^{n} - 1 ] \qquad \text{Eq. 7}$$

This final formula states that for any given initial compensation, “I_{c}”, years to retirement “n” and % compensation deferral, one can immediately calculate final account balance (using a compensation inflation of “i_{w}” and investment return of “Iₐ”). It is important to note that the wage inflation that will actually build the account values is the actual or experienced wage inflation. That used for modeling is of course fictitious. The final account balance may not be the vested benefit, however. This would only be the projected final account accrual in the preferred embodiment of the invention, used for modeling the liability of an account.

Lastly, we need to derive formulas which will describe the account balances after withdrawals commence. Generally, a more conservative approach would illustrate withdrawals in the beginning of a year, and then allow for growth throughout the year. We will use this approach. Then, by induction, if “Fᵣ” is the final account balance accrued through retirement (as given by Equation 7 where Fₐ=Fᵣ), then “Fᵣ−Y” is the account balance after a retirement withdrawal “Y” has occurred. Then, (Fᵣ−Y)*(1+iₐ) is the account balance after the first year, but before the next year's withdrawal. Obviously then, “(Fᵣ−Y)*(1+iₐ)−Y” is the account balance after the next year's withdrawal, and so forth. The “Y” withdrawal in this example behaves as a straight life annuity pension settlement option. It could be any pension type settlement option but, for ease of derivation and by way of example, we'll use the straight life annuity option for consistency in all mathematics and by way of demonstration. The resultant equation for the account balance whence disbursements commence (after retirement), is then given by:

$${{F}_{r} ( 1 + {i}_{a} )}^{z} - Y {\sum }_{s = 1}^{z} {( 1 + {i}_{a} )}^{s} \qquad \text{Eq. (8)}$$

Where all the parameters have been defined before except “z” which is years after disbursement commencement or years from the beginning of distributions. This equation can then be simplified by finding the convergence of the series. This will result in the following equation:

$${{F}_{r} ( 1 + {i}_{a} )}^{z} - \frac{Y}{{i}_{a}} [ {( 1 + {i}_{a} )}^{z + 1} - ( 1 + {i}_{a} ) ] \qquad \text{Eq. (9)}$$

This last equation then allows for the immediate calculation of the account balance “z” years away from retirement or “z” years after the beginning of distributions. The retirement withdrawals themselves, Y, are calculated from summing the Annual Vested Benefit (to be derived, the Master Equation) each and every year and then multiplying that fraction times the final or final average compensation. Thus the “Y” is the compensation replacement ratio obtained from the present invention's benefit option, while the Fᵣ is the final account balance accrued during the accumulation phase of the retiree's working career.

Now of concern to the asset manager of the plan is that if the factors “Y”, the yearly withdrawals, are a larger percentage of total assets Fᵣ, than is the investment return, iₐ, we can solve for how long it will take to deplete the assets. That is, if yearly withdrawals are 10% of proceeds while the investment return averages 8%, then obviously the account holder is on an asset depletion schedule. By setting Equation 9 to zero and solving for “z” we arrive at an equation which will allow us to determine about how long the money will last for the account holder on this asset depletion schedule. Then,

$$z = [ \frac{log ( \frac{- Y ( 1 + {i}_{a} )}{{F}_{r} {i}_{a} - Y ( 1 + {i}_{a} )} )}{log ( 1 + {i}_{a} )} ] \qquad \text{Eq. (10)}$$

This last equation tells us “how the long the money will last” but is only valid when “Fᵣiₐ−Y(1+iₐ)” is less than zero or when “Fᵣiₐ<Y(1+iₐ)”, or else the implication is that the money will last forever. We are finished with deriving equations for account balances. These are necessary to allow for a monitoring of the liability of an account or plan, but are generally not vested benefits, they are however of chief concern to investment advisors or insurers.

B) Equations for final vested benefit using life annuity settlement option.

The next derivation will account for the amount of vested benefit and is really the embodiment of the invention. First, let us assume retirement settlement options are nothing more than a single straight life annuity by way of example. In the preferred embodiment, any settlement option may be utilized. We won't illustrate any mathematics for lump sum withdrawals and likewise will disallow other annuity settlement options at this time for brevity. However, the derivations that follow are similarly constructed using any annuity settlement option formula in place of the straight life annuity due to their actuarial equivalence.

The periodic payment of an annuity may be given by:

$$\frac{{Fi}_{a}}{[ 1 - ( \frac{1}{{( 1 + {i}_{a} )}^{m}} ) ]} = Annuitized Periodic Income \qquad \text{Eq. (11)}$$

where “F” is some account value and the other parameters in this equation have been previously identified. The superscript “m” is the life expectancy after retirement of the account holder. The life expectancy is an actuarial estimate of when someone has a 50% probability of living from his or her present age to some future age. If the account holder retires at age 65 and is expected to live until age 81 (50% probability of living from age 65 to 81) for example, then “m” takes the value of 17 (81-64). One includes the age 65 so the difference is computed from age 64.

One difficulty with the above equation however, is that it is known that cash flows predicted using this equation for annuities, given life expectancies, will “underestimate” that experienced by a large population. Thus, for group statistics, there is an actuarially defined straight life annuity formula, which offers an annuitized periodic income given by:

$$\frac{F}{{\sum }_{t = 0}^{infinity} {v}^{t} {\prod }_{s = 0}^{t - 1} {P}_{r + s}^{m}} = \frac{F}{1 + \frac{{P}_{r}^{m}}{1 + {i}_{a}} + \frac{{P}_{r}^{m} {P}_{r + 1}^{m}}{1 + {i}_{a}^{2}} - \frac{{P}_{r}^{m} {P}_{r + 1}^{m} {P}_{r + 2}^{m}}{1 + {i}_{a}^{3}} + … } \qquad \text{Eq. (12)}$$

where Pᵣ^{m} is the probability of dying at age “r” the retirement age. In this equation alone “m” stands for mortality, in all previous equations it stood for life expectancy. This equation as shown is still to be used for individuals. One would use this equation when calculating the pension payout for a group of account holders, such as when the accounts comprise a plan, in which case this equation is used for each individual in the group where the group mortalities are given by the “P” descriptors. Then the expansion of the product is essentially the probability of living from age r to some old age (numerically, the product collapses after around age 100, i.e., t=100). There are similar formulae like this one for other retirement or annuity settlement options like joint survivor, or period certain, etc. This formula is encountered again in the description of actuarial liabilities in the next section. In the preferred embodiment of the invention, any of these equations may be substituted in the derivations for the Annuitized Periodic Income to develop closed end analytical formulas. For instance, this latter formula can be substituted for any equation using life expectancies in a program designed to model the liabilities. However, for the remainder of this description, we'll use the previous equation for “Annuitized Periodic Income”, dependent upon the life expectancy parameter “m”, strictly for the ease of derivation and for demonstration purposes.

Now to continue toward our derivation of the Annual Vested Benefit, we need to use an “Annuitized Periodic Income” equation in combination with a compensation equation. Any compensation equation will do. First, percent of compensation deferral (the annual contribution) multiplied by the initial entry compensation “I_{c}” multiplied by “(1+iₐ)ⁿ⁻¹” is the value of a single contribution after “n” years. If we now set “%_{deferral} I_{c}(1+iₐ)ⁿ⁻¹” equal to the account value parameter “F” in the Annuitized Periodic Income equation, we have the amount of income in dollars the account holder will receive at disbursement time. This formula then can be divided by the standard compensation equation or final compensation at retirement and, after doing so and rearranging, we arrive at the following equation:

$$Annual Vested Benefit = \frac{\% deferral {{i}_{a} ( 1 + {i}_{a} )}^{n - 1 + m} {( 1 + {i}_{c} )}^{1 - n}}{{( 1 + {i}_{a} )}^{m} - 1} \qquad \text{Eq. (2)}$$

This is the Master Equation. Here we have the percent of the employee's contribution for each year, which is vested against his final compensation. For instance, if an employee contributed 8% of his compensation for this year, the amount of vested retirement benefit he would have purchased for this year is 1.72% of final compensation (assuming 5% wage inflation (i_{c}), investment returns of 8% (iₐ), 30 years until retirement (n) and 24 years of life expectancy (m) after retirement) computed using Equation 13.

This equation expresses the account holder's guarantee as a function of final compensation and is unique. What is important about this equation is that the promise or guarantee to the account holder made with this equation may use some other investment return iₐ then what the insurer or investment manager expects to achieve. Thus, the amount promised as a percent of final compensation would be based upon some risk adjusted return that may be “less” than the expected investment return over the time horizon, and allow for a hedge against compensation inflation. In other words, the spread between the iₐ used to make the promise through Equation 13 and the expected investment return can be adjusted to allow for higher or lower risk adjusted returns.

This is an important result and it is important to note that it is pension settlement option independent, although we derived it after choosing the settlement option of straight life annuity. It could likewise be derived using any closed end analytical formula for any settlement option. If we had chosen another settlement option like joint survivor or period certain, then the annuitized periodic income equation would be expressed differently, resulting in a different equation for the annual vested benefit as well, but still offer the guarantee in terms of percent of final compensation. If we chose another wage equation or assumption, the derivation would have been straight forward as well. It would mean a different annual vested benefit equation would be formed, but it would again make the same guarantee. Thus, a master formula has been developed for “Annual Vested Benefit” allowing us to calculate the guaranteed benefit regardless of which wage equation, or settlement option is chosen.

Expressions for annuitized periodic income for differing settlement options are mortality table dependent and involve terms that are products of death probabilities as shown previously. This would make the math more difficult but still very tractable and allow for terms to be expressed analytically if one wishes, just as in Equation 13 for Annual Vested Benefit. This is why we claim the method is settlement option independent.

If one calculates Equation 13 for all contributions over the worker's employment history and adds them together one would obtain the employee's final vested compensation replacement benefit. If the compensation percent deferred is constant throughout the work history of the employee, the equation to compute the final Retirement Benefit (i.e., compensation replacement benefit) is given by:

$$\frac{{i}_{a}}{[ 1 - ( \frac{I}{{( 1 + {i}_{a} )}^{m}} ) ]} \frac{\% deferral {( 1 + {i}_{a} )}^{n}}{( {i}_{c} - {i}_{a} ) {( 1 + {i}_{c} )}^{n - 1}} [ {( \frac{( 1 + {i}_{c} )}{( 1 + {i}_{a} )} )}^{n} - 1 ] \qquad \text{Eq. (14)}$$

which can be rearranged to give the following concise formula:

$$Retirement Benefit = \frac{\% deferral {i}_{a} [ {( 1 + {i}_{a} )}^{m} - {( 1 + {i}_{a} )}^{( n + m )} {( 1 + {i}_{c} )}^{- n} ] ( 1 + {i}_{c} )}{( {i}_{c} - {i}_{a} ) [ {( 1 + {i}_{a} )}^{m} - 1 ]} \qquad \text{Eq. (3)}$$

Thus, if the contribution percentages do not change each year one can use Equation 15 to determine the employee's final compensation replacement level at retirement. Otherwise, for changing contributions, Equation 13 has to be calculated each and every year to determine the vested percentage of final compensation replacement. This would be required for each year's contributions and summed over all years to obtain the employee's final compensation replacement ratio.

Floor or ceiling guarantee levels are controlled by the investment return used to make the promise compared with that investment return expected to be obtained in experience, on average. Thus, Equations 13 and 15 may make a promise to an account holder based upon one investment performance and wage inflation figure, while experience may be something else. The lower the investment return iₐ used in these equations and the higher the wage inflation i_{c} used, the greater the probability in obtaining a modeled result and the lower the liability of the plan. One may not have a ceiling on the benefit however, in some embodiment of the invention, so it is not necessary to try and place limitations on the benefit.

There are at least two purposes for these equations. First, to calculate an account holder's account benefit and second, to try and model a whole group of account holders to gage the liability of a population, such as with a guaranteed benefits plan. In both cases, it might be to administer an active account, or to create and develop a product. All of these equations have been developed for an individual account. The probabilities of modeling the liability accurately depends upon many account holders being available and enrolled. For instance, these compensation equations use a compensation formula that has limitations and is useful only if we say, “given 10,000 workers, this equation will model their average final compensation”. It is tenuous to expect to use these equations to accurately model or predict any individual's future liability; thus one clearly has to have the “law of large numbers” in his favor for statistical credibility.

With respect to compensation inflation alone, for instance, given an average employee census, some workers will become CEO's and have significant bonus income, while other workers will have compensation stagnation. Another example might be that many workers will have compensation inflation less than “i_{c}” even though some workers may have higher compensation inflation. Maybe their combined inflation rate might be “i_{c}” so that solution of the compensation equation represents the “average” worker.

We should also note that, although the account holder's life expectancy is utilized in these equations to calculate a guaranteed benefit, one doesn't necessarily have to consider this explicitly while calculating the economic liability of a guaranteed benefit plan. Other forms of the annuity settlement option are available to mitigate the effects of life expectancies known underestimation of plan liabilities. However, for demonstration purposes and by way of illustration, it's easier to communicate the results through derivations with an equation that uses life expectancies. In fact, for defined benefit liabilities, one uses actuarial liabilities to model the liability of the plan where probabilities of living are accounted for year over year, throughout the entire life of an individual account holder.

Actuarial Liability Using Life Annuity Settlement Option

The next step involves applying the actuarial liability formulas from pension theory. Although there are five main methods to choose from¹ for computing a pension liability, they all begin with similar accounting. Generally, the actuarial liability using the Benefit Prorate-Unit Credit Method has the following form:

$${AL}_{iability} = \frac{Cx}{Cr} {B}_{r} ( {nP}_{x}^{T} ) {v}^{n} {a}_{r} \\ where \\ {nP}_{x}^{T} = {\prod }_{t = 0}^{n - 1} {P}_{( x + t )}^{T} \\ {v}^{n} = \frac{1}{{( 1 + i )}^{n}} \\ {a}_{r} = {\sum }_{t = 1}^{infinity} ( {\prod }_{s = 0}^{t - 1} {P}_{r + s}^{m} ) {v}^{t} \\ \text{Eqs. (16} a– \text{16} d \text{, respectively)} \qquad \text{Eq. (5)}$$

In these equations Cₓ and Cᵣ are entry compensation and retirement compensation, respectively. The “Bᵣ” is the accrued pension benefit based upon a compensation percent multiple or dollars per year of service and is usually plan specific. This parameter and how it is defined is what differentiates the different actuarial liability methods. The term shown in parentheses in Equation 16a, which is defined in the Equation 16b, is the probability that an employee aged ‘x’, will survive another “n” years with the employer who sponsors a defined benefit plan, whose liability is being calculated. The ‘T’ superscript indicates its a total probability, made up of mortality, disability, turnover and retirement. Equation 16c defines the discount function ‘vⁿ’ which plays the role of “net present value”. It is this function which allows the accrued liability to be present valued. The parameter ‘aᵣ’ is defined in Equation 16d and is written as the present value of a straight life annuity. It is a constant for a given discount rate shown in the v^{t} function (Equation 16c), given mortality table and given retirement age. Other forms of ‘aᵣ’ exist for different pension settlement options like “Period Certain” and “Joint Survivor Annuity”.

Lastly, the terms in P on the right side of Equations 16a-16d are the individual probabilities of an employee surviving one year. The subscript ‘x’ in Equation 16b represents the current age of the employee while the ‘r’ in Equation 16d generally means age 65, the retirement age. The superscripts ‘T’ and ‘m’ represent total (mortality, disability, turnover and retirement) and mortality probabilities. For example, in calculations performed in this disclosure, the mortality probabilities are given by the 1983 GAM tables.

Having defined the actuarial liability of a defined benefit plan, we have to make some adjustments before using this equation in our analysis/derivation. All terms in this equation, except “Bᵣ”, in Equation 16a can be used exactly as shown. The parameter Bᵣ only has to be defined to calculate the liability of the present invention as a plan. It's logical to use the employee's Retirement Benefit formula (Equation 15) for this function, since Bᵣ traditionally represents the amount of retirement benefit the employee is entitled to in a defined benefit plan.

Thus the actuarial liability is determined by combining Equations 15 and 16a-16d above by substituting Equation 15 for Bᵣ in Equation 16a while omitting the initial to final compensation ratio. Thus the following form is assumed for employee's deferring a constant percentage of compensation into the plan:

$${AL}_{GRIP} = \frac{\begin{matrix}\% deferral {i}_{a} Cx [ {( 1 + {i}_{a} )}^{m} - \\ {( 1 + {i}_{a} )}^{( n + m )} {( 1 + {i}_{c} )}^{- n} ] ( 1 + {i}_{c} )\end{matrix}}{Cr ( {i}_{c} - {i}_{a} ) [ {( 1 - {i}_{a} )}^{m} - 1 ]} \frac{{\prod }_{t = 0}^{n - 1} {P}_{{( x + t )}^{T}}}{{( 1 + i )}^{n}} {\sum }_{t = 1}^{infinity} \frac{( {\prod }_{z = 0}^{t - 1} {P}_{( r + z )}^{m} )}{{( 1 + i )}^{t}} \qquad \text{Eq. (6)}$$

This equation is an actuarial liability for the present invention as a guaranteed benefit plan under the following conditions: standard compensation equation, constant percent participation level compensation deferral, straight life annuity benefit payment where the guarantee is made as a percentage of final compensation. With respect to the investment return utilized in Equations 13 and 15 and here in Equation 17, there is no need for the promise or guarantee offered by these equations in terms of retirement benefit to be identical to that expected from actual investment performance. In fact, using a lower than expected investment return and a higher than expected wage inflation rate will lower the liability of the plan and allow for greater profits.

Lastly, it will be more satisfactory to use a wage equation that is a linear combination of the two given in the beginning of this description; in this way the coefficients can be chosen to create any compensation path one chooses. Also, the guaranteed benefit of the present invention, could be expressed as a percent of career average compensation rather than as a percent of final compensation as that will mitigate expensive account holder liabilities due to higher than normal wage inflation, and assuage the worries of the account holder with lower than expected wage inflation.

The present invention, due to the complexity of the equations and formulae, and tremendous data input, manipulation, record keeping, storage and output requirements, must be implemented by a computer. Three examples of implementation of the plan of the present invention follow:

### EXAMPLE 1

The first example will demonstrate how to calculate the projected lump sum and benefit payout for an account holder of a plan who is now at an entry age of the plan of 25, earning $30,000 per year and is wishing to defer 8% of his compensation. The account holder believes he will be able to continue this compensation deferral rate throughout his career to retire at age 65 and is wondering what kind of final compensation replacement benefit he will purchase. This involves the following steps.

A: First, calculate the information of concern to the participant.

1) Assume a compensation inflation rate and compensation inflation equation, guaranteed investment rate and a life expectancy.

Wage inflation: 5.1%; Standard equation; Guaranteed investment rate: 7.0%; Expected investment rate: 9.0%; Life expectancy: 17.2738 (interpolated from 83 GAM tables).

2) Calculate his Retirement Benefit based upon 8% compensation deferral for his lifetime participation using Equation 15 supra. This shows the client his expected compensation replacement ratio at retirement but is not guaranteed.

Vested Benefit at age 65 is expected to be 48.75% of final compensation, but this is not guaranteed until contributions are made.

3) Calculate the client's Annual Vested Benefit (Equation 13) after the first year's contribution. This is the guarantee for a single year's contribution BUT the guarantee is not active until a full year's contributions are received. Then, after receiving a full year's contributions, the amount of compensation replacement this money purchases is “locked in” and the guarantee extends until distribution for that one year's contributions. This is done each and every year for each year's contribution.

These are guaranteed, so that after the first year's contributions are received, the client has 1.66% of his final compensation, whatever it is, “locked” in. After the 3rd year's contributions, a total of 4.9% of final compensation is guaranteed at retirement age of 65.

B: Now we will look at the feasibility of the account by examining the final account balance based upon some realistic investment return (greater than the guaranteed investment rate) and a compensation inflation rate that might be expected based upon the account holder's occupation. This is of concern to the guarantor and is the liability of the account.

1) Calculate the final account for the account holder using Equation 7 supra with these expected investment return and compensation inflation rates.

This is $1,633,851 at age 65.

2) Calculate the retirement age final compensation using this compensation inflation rate with the same compensation equation used in step A above.

This is $219,397 at age 65.

3) Multiply the Retirement Benefit (compensation replacement ratio) obtained from step A times the participant's final compensation to calculate “Y” from Equations 16a-16d supra. This is the participant's expected annuity payment.

This annuity payment is projected to be 48.75% of $219,397 or $106,947 per year at retirement.

4) Substitute the final retirement account balance, and annuity Y just calculated in Equations 16a-16d supra for all years “z”. In so doing one will have the account balance supporting the cash flows “Y” for the lifetime of the account holder. From here the liability can be looked at depending upon how the actuary wants to deal with it, either carrying Y withdrawals out to the account holder's life expectancy or by multiplying Y times the probability of living each and every year out to where it's zero (age 110 for instance)

The money will last forever as withdrawals begin at ($106,947 divided by $1,633,851) 6.55% of the account balance, while the expected investment return is at 9%.

EXAMPLE 1

| | |
|---|---|
| Initial Compensation @ Age 25 | $30,000 |
| Projected Final Age 65 Compensation | $219,397 |
| Age Retirement Benefits Begin | 66 |
| Life Expectancy After Retirement | 17.2738 |
| Account Balance at Retirement | $1,633,851 |
| Guaranteed Return | 7.0% |
| Expected Investment Return | 9.0% |
| Wage Inflation Rate | 5.1% |
| Projected Compensation Replacement Ratio @ 8% | 48.75% |
| Cont. Rate | |
| Vested Retirement Benefit | 0.00% |
| How Long the Money Will Last | Forever |

| | Years | | | | | | | Guaranteed |
|---|---|---|---|---|---|---|---|---|
| | Retirement | | | | | | Annual | or Vested |
| | Benefits | | | Deferral | Account | Benefit | Vested | Retirement |
| Year | Begin | Age | Compensat. | Percentage | Balance | Payout | Benefit | Benefit |
| 0 | 41 | 25 | 30,000 | 8.0% | 2,400 | 0 | 1.66% | 1.66% |
| 1 | 40 | 26 | 31,530 | 8.0% | 5,138 | 0 | 1.63% | 3.30% |
| 2 | 39 | 27 | 33,138 | 8.0% | 8,252 | 0 | 1.61% | 4.90% |
| 3 | 38 | 28 | 34,828 | 8.0% | 11,781 | 0 | 1.58% | 6.48% |
| 4 | 37 | 29 | 36,604 | 8.0% | 15,769 | 0 | 1.55% | 8.03% |
| 5 | 36 | 30 | 38,471 | 8.0% | 20,266 | 0 | 1.52% | 9.55% |
| 6 | 35 | 31 | 40,433 | 8.0% | 25,325 | 0 | 1.49% | 11.04% |
| 7 | 34 | 32 | 42,495 | 8.0% | 31,004 | 0 | 1.47% | 12.51% |
| 8 | 33 | 33 | 44,662 | 8.0% | 37,367 | 0 | 1.44% | 13.95% |
| 9 | 32 | 34 | 46,940 | 8.0% | 44,485 | 0 | 1.42% | 15.37% |
| 10 | 31 | 35 | 49,334 | 8.0% | 52,436 | 0 | 1.39% | 16.76% |
| 11 | 30 | 36 | 51,850 | 8.0% | 61,303 | 0 | 1.37% | 18.13% |
| 12 | 29 | 37 | 54,495 | 8.0% | 71,180 | 0 | 1.34% | 19.47% |
| 13 | 28 | 38 | 57,274 | 8.0% | 82,168 | 0 | 1.32% | 20.78% |
| 14 | 27 | 39 | 60,195 | 8.0% | 94,379 | 0 | 1.29% | 22.08% |
| 15 | 26 | 40 | 63,265 | 8.0% | 107,934 | 0 | 1.27% | 23.35% |
| 16 | 25 | 41 | 66,491 | 8.0% | 122,968 | 0 | 1.25% | 24.60% |
| 17 | 24 | 42 | 69,882 | 8.0% | 139,625 | 0 | 1.23% | 25.83% |
| 18 | 23 | 43 | 73,446 | 8.0% | 158,067 | 0 | 1.21% | 27.03% |
| 19 | 22 | 44 | 77,192 | 8.0% | 178,469 | 0 | 1.18% | 28.22% |
| 20 | 21 | 45 | 81,129 | 8.0% | 201,021 | 0 | 1.16% | 29.38% |
| 21 | 20 | 46 | 85,266 | 8.0% | 225,934 | 0 | 1.14% | 30.52% |
| 22 | 19 | 47 | 89,615 | 8.0% | 253,438 | 0 | 1.12% | 31.64% |
| 23 | 18 | 48 | 94,185 | 8.0% | 283,782 | 0 | 1.10% | 32.74% |
| 24 | 17 | 49 | 98,989 | 8.0% | 317,241 | 0 | 1.08% | 33.83% |
| 25 | 16 | 50 | 104,037 | 8.0% | 354,116 | 0 | 1.06% | 34.89% |
| 26 | 15 | 51 | 109,343 | 8.0% | 394,734 | 0 | 1.04% | 35.93% |
| 27 | 14 | 52 | 114,920 | 8.0% | 439,453 | 0 | 1.03% | 36.96% |
| 28 | 13 | 53 | 120,781 | 8.0% | 488,667 | 0 | 1.01% | 37.97% |
| 29 | 12 | 54 | 126,940 | 8.0% | 542,802 | 0 | 0.99% | 38.96% |
| 30 | 11 | 55 | 133,414 | 8.0% | 602,327 | 0 | 0.97% | 39.93% |
| 31 | 10 | 56 | 140,219 | 8.0% | 667,754 | 0 | 0.95% | 40.38% |
| 32 | 9 | 57 | 147,370 | 8.0% | 739,642 | 0 | 0.94% | 41.82.% |
| 33 | 8 | 58 | 154,886 | 8.0% | 818,600 | 0 | 0.92% | 42.74% |
| 34 | 7 | 59 | 162,785 | 8.0% | 905,297 | 0 | 0.90% | 43.65% |
| 35 | 6 | 60 | 171,067 | 8.0% | 1,000,461 | 0 | 0.89% | 44.53% |
| 36 | 5 | 61 | 179,812 | 8.0% | 1,104,867 | 0 | 0.87% | 45.41% |
| 37 | 4 | 62 | 188,983 | 8.0% | 1,219,446 | 0 | 0.86% | 46.26% |
| 38 | 3 | 63 | 198,621 | 8.0% | 1,345,085 | 0 | 0.84% | 47.11% |
| 39 | 2 | 64 | 208,750 | 8.0% | 1,482,843 | 0 | 0.83% | 47.93% |
| 40 | 1 | 65 | 219,397 | 8.0% | 1,633,851 | 0 | 0.81% | 48.75% |
| 41 | 1 | 66 | | | 1,664,325 | 106,947 | | |
| 42 | 2 | 67 | | | 1,697,541 | 106,947 | | |
| 43 | 3 | 68 | | | 1,733,747 | 106,947 | | |
| 44 | 4 | 69 | | | 1,773,212 | 106,947 | | |
| 45 | 5 | 70 | | | 1,316,228 | 106,947 | | |
| 46 | 6 | 71 | | | 1,363,116 | 106,947 | | |
| 47 | 7 | 72 | | | 1,914,224 | 106,947 | | |
| 43 | 8 | 73 | | | 1,969,932 | 106,947 | | |
| 49 | 9 | 74 | | | 2,030,653 | 106,947 | | |
| 50 | 10 | 75 | | | 2,096,839 | 106,947 | | |
| 51 | 11 | 76 | | | 2,168,982 | 106,947 | | |
| 32 | 12 | 77 | | | 2,247,617 | 106,947 | | |
| 53 | 13 | 78 | | | 2,333,330 | 106,947 | | |
| 54 | 14 | 79 | | | 2,426,758 | 106,947 | | |
| 55 | 15 | 80 | | | 2,528,593 | 106,947 | | |
| 56 | 16 | 81 | | | 2,639,594 | 106,947 | | |
| 57 | 17 | 82 | | | 2,760,585 | 106,947 | | |
| 58 | 13 | 83 | | | 2,892,465 | 106,947 | | |
| 59 | 19 | 84 | | | 3,036,214 | 106,947 | | |
| 60 | 20 | 85 | | | 3,192,900 | 106,947 | | |
| 61 | 21 | 86 | | | 3,363,689 | 106,947 | | |
| 62 | 22 | 87 | | | 3,549,843 | 106,947 | | |
| 63 | 23 | 88 | | | 3,752,762 | 106,947 | | |
| 64 | 24 | 89 | | | 3,973,938 | 106,947 | | |
| 65 | 25 | 90 | | | 4,215,019 | 106,947 | | |
| 66 | 26 | 91 | | | 4,477,799 | 106,947 | | |
| 67 | 27 | 92 | | | 4,764,228 | 106,947 | | |
| 68 | 28 | 93 | | | 5,076,436 | 106,947 | | |
| 69 | 29 | 94 | | | 5,416,742 | 106,947 | | |
| 70 | 30 | 95 | | | 5,787,676 | 106,947 | | |
| 71 | 31 | 96 | | | 6,191,995 | 106,947 | | |
| 72 | 32 | 97 | | | 6,632,702 | 106,947 | | |
| 73 | 33 | 98 | | | 7,113,072 | 106,947 | | |
| 74 | 34 | 99 | | | 7,636,676 | 106,947 | | |
| 75 | 35 | 100 | | | 8,207,404 | 106,947 | | |
| 76 | 36 | 101 | | | 8,829,498 | 106,947 | | |
| 77 | 37 | 102 | | | 9,507,580 | 106,947 | | |
| 78 | 38 | 103 | | | 10,246,689 | 106,947 | | |
| 79 | 39 | 104 | | | 11,052,319 | 106,947 | | |
| 80 | 40 | 105 | | | 11,930,455 | 106,947 | | |
| 81 | 41 | 106 | | | 12,887,623 | 106,947 | | |
| 82 | 42 | 107 | | | 13,930,937 | 106,947 | | |
| 83 | 43 | 106 | | | 15,068,148 | 106,947 | | |
| 84 | 44 | 109 | | | 16,307,709 | 106,947 | | |
| 85 | 45 | 110 | | | 17,658,830 | 106,947 | | |

### EXAMPLE 2

Here, we will demonstrate how to calculate the projected lump sum and benefit payout for an account holder who started at age 25, initial compensation of $30,000 per year, 8% deferral of compensation, where he is now age 40 and wishes to change deferrals to 15% of compensation. Originally, he was planning to retire at age 65. Thus, he has been in the account for 15 years and has some history of vesting of his contributions at an 8% deferral rate during his employment. His current compensation is $75,000 per year. The participant believes he will be able to continue this latter compensation deferral rate throughout his remaining career and wants to retire now at age 60 instead of age 65 and is wondering what kind of final compensation replacement benefit he will purchase if he does this.

A: First, calculate the information of concern to the account holder.

1) Calculate the compensation inflation rate from his initial to current compensation, and choose a compensation inflation equation for his remaining working years, a guaranteed investment rate and a life expectancy after age 65.

Compensation inflation: 5.1%; Standard equation; Original compensation inflation projection was based upon 5.1% for the client. But his compensation history has been at the 6.3% rate, thus we know the guarantor is at risk with this client somewhat. Guaranteed investment rate: 7.0%; Expected investment rate: 9.0%; Life expectancy: 22.2738 because he is retiring 5 years earlier.

2) Obtain his vested or guaranteed Retirement Benefit based upon his initial 8% compensation deferral for the first 15 years, then calculate his remaining retirement benefit at 15% deferral level using Equation 15 supra. This shows the client his expected compensation replacement ratio at retirement but is not guaranteed.

Vested Retirement Compensation Replacement: 23.35% of final compensation after 15 years contributions at 8% of compensation. This 23.35% is Guaranteed. If from the 16th year onward, contributions increase to 15% of compensation, then the client may expect final compensation replacement of 55.50% of final compensation.

3) Tabulate the account holder's Annual Vested Benefit (Equation 13) from the first year in the account until year 15. Then calculate these out until age 60. These are the single year guarantees BUT the remaining guarantees are not active until receipt of the remaining contributions.

The Annual Vested Benefit increases dramatically from age 40 to age 41, after the adjustment of contributions from 8% to 15%. This is because the larger contribution purchases a greater percent of his final compensation. On the other hand, notice the “Years Retirement Benefits Begin” column. At the 15th to 16th year transition, notice the drop from 26 to 20 years until benefits commence. This will in effect work to lower the amount of “Annual Vested Benefit” purchased with contributions, but not enough to offset the increase due to higher contribution rates.

B: Now we will look at the feasibility of the account by examining the final account balance based upon some realistic investment return (greater than the guaranteed investment rate) and a wage inflation rate that might be expected based upon the account holder's occupation. This is of concern to the guarantor and is the liability of the account.

1) Calculate the final account for the account holder using Equation 7 supra with these expected investment return and wage inflation rates.

This is $1,632,883 at age 60. Currently, at age 40 the account balance is already $116,654 which is vested.

2) Calculate the retirement age final compensation using compensation wage inflation rate with the same compensation equation used in step A above.

Age 60 compensation is $254,477.

3) Multiply the Retirement Benefit (compensation replacement ratio) obtained from step A times his final compensation to calculate “Y” from Equations 16a-d supra. This is the account holder's expected annuity payment.

Multiply 55.50% times $254,477 and arrive at $141,247 per year is the pension payment.

4) Substitute the final retirement account balance, and annuity Y just calculated in Equations 16a-d for all years “z”. In so doing one will have the account balance supporting the cash flows “Y” for the lifetime of the account holder. From here the liability can be looked at depending upon how the actuary wants to deal with it, either carrying Y withdrawals out to the account holder's life expectancy or by multiplying Y times the probability of living each and every year out to where it's zero (age 110 for instance).

The money will last 35.87 years past retirement at age 60 (over age 95 of the client) as withdrawals begin at ($141,247 divided by $1,632,883) 8.65% of the account balance, while the expected investment return is at 9%, except that the withdrawals occur before growth in the model. This is a more conservative approach and will tend to exacerbate the circumstances of withdrawal from total return.

EXAMPLE 2

| | Age 25 | | Age 40 | |
|---|---|---|---|---|
| Compensation | $30,000 | | $75,000 | |
| Projected | $219,397 | | $254,477 | |
| Retirement | | | | |
| Age | | | | |
| Compensation | | | | |
| Age | 66 | | 61 | |
| Retirement | | | | |
| Benefits Begin | | | | |
| Life Expectancy | 17.2738 | | 22.2738 | |
| After | | | | |
| Retirement | | | | |
| Account Balance | | | $1,632,883 | |
| at Retirement | | | | |
| Guaranteed | 7.0% | | 7.0% | |
| Return | | | | |
| Expected | 9.0% | | 9.0% | |
| Investment | | | | |
| Return | | | | |
| Compensation | 5.1% | Ac- | 6.3% | |
| Inflation Rate | | tual | | |
| | | Com- | | |
| | | pens. | | |
| | | Infla- | | |
| | | tion | | |
| Projected | 48.75% | | 55.50% | |
| Compensation | | | | |
| Replacement | | | | |
| Ratio | | | | |
| Vested | 0.0% | | 23.35% | |
| Retirement | | | | |
| Benefit | | | | |
| How Long the | Forever | | 35.87 | Years |
| Money Will Last | | | | after |
| | | | | re- |
| | | | | tire- |
| | | | | ment |

| | Years | | | | | | | Guaranteed |
|---|---|---|---|---|---|---|---|---|
| | Retirement | | | | | | Annual | or Vested |
| | Benefits | | | Deferral | Account | Benefit | Vested | Retirement |
| Year | Begin | Age | Compens. | Percentage | Balance | Payout | Benefit | Benefit |
| 0 | 41 | 25 | 30,000 | 8.0% | 2,400 | 0 | 1.66% | 1.66% |
| 1 | 40 | 26 | 31,890 | 8.0% | 5,167 | 0 | 1.63% | 3.30% |
| 2 | 39 | 27 | 33,898 | 8.0% | 8,344 | 0 | 1.61% | 4.90% |
| 3 | 38 | 28 | 36,034 | 8.0% | 11,978 | 0 | 1.58% | 6.48% |
| 4 | 37 | 29 | 38,304 | 8.0% | 16,120 | 0 | 1.55% | 8.03% |
| 5 | 36 | 30 | 40,716 | 8.0% | 20,828 | 0 | 1.52% | 9.55% |
| 6 | 35 | 31 | 43,281 | 8.0% | 26,165 | 0 | 1.49% | 11.04% |
| 7 | 34 | 32 | 46,007 | 8.0% | 32,201 | 0 | 1.47% | 12.51% |
| 8 | 33 | 33 | 48,905 | 8.0% | 39,011 | 0 | 1.44% | 13.95% |
| 9 | 32 | 34 | 51,986 | 8.0% | 46,681 | 0 | 1.42% | 15.37% |
| 10 | 31 | 35 | 55,260 | 8.0% | 55,303 | 0 | 1.39% | 16.76% |
| 11 | 30 | 36 | 58,741 | 8.0% | 64,980 | 0 | 1.37% | 18.13% |
| 12 | 29 | 37 | 62,441 | 8.0% | 75,823 | 0 | 1.34% | 19.47% |
| 13 | 28 | 38 | 66,375 | 8.0% | 87,957 | 0 | 1.32% | 20.78% |
| 14 | 27 | 39 | 70,556 | 8.0% | 101,518 | 0 | 1.29% | 22.08% |
| 15 | 26 | 40 | 75,000 | 8.0% | 116,654 | 0 | 1.27% | 23.35% |
| 16 | 20 | 41 | 79,724 | 15.0% | 139,112 | 0 | 1.90% | 25.25% |
| 17 | 19 | 42 | 84,746 | 15.0% | 164,344 | 0 | 1.86% | 27.11% |
| 18 | 18 | 43 | 90,084 | 15.0% | 192,648 | 0 | 1.83% | 28.94% |
| 19 | 17 | 44 | 95,759 | 15.0% | 224,350 | 0 | 1.80% | 30.73% |
| 20 | 16 | 45 | 101,791 | 15.0% | 259,810 | 0 | 1.76% | 32.50% |
| 21 | 15 | 46 | 108,202 | 15.0% | 299,423 | 0 | 1.73% | 34.23% |
| 22 | 14 | 47 | 115,018 | 15.0% | 343,624 | 0 | 1.70% | 35.94% |
| 23 | 13 | 48 | 122,263 | 15.0% | 392,889 | 0 | 1.67% | 37.61% |
| 24 | 12 | 49 | 129,965 | 15.0% | 447,744 | 0 | 1.64% | 39.25% |
| 25 | 11 | 50 | 138,151 | 15.0% | 508,764 | 0 | 1.61% | 40.86% |
| 26 | 10 | 51 | 146,853 | 15.0% | 576,581 | 0 | 1.58% | 42.45% |
| 27 | 9 | 52 | 156,104 | 15.0% | 651,888 | 0 | 1.56% | 44.01% |
| 28 | 8 | 53 | 165,937 | 15.0% | 735,449 | 0 | 1.53% | 45.54% |
| 29 | 7 | 54 | 176,389 | 15.0% | 828,098 | 0 | 1.50% | 47.04% |
| 30 | 6 | 55 | 187,500 | 15.0% | 930,751 | 0 | 1.48% | 48.51% |
| 31 | 5 | 56 | 199,311 | 15.0% | 1,044,416 | 0 | 1.45% | 49.96% |
| 32 | 4 | 57 | 211,865 | 15.0% | 1,170,193 | 0 | 1.42% | 51.38% |
| 33 | 3 | 58 | 225,211 | 15.0% | 1,309,292 | 0 | 1.40% | 52.78% |
| 34 | 2 | 59 | 239,397 | 15.0% | 1,463,038 | 0 | 1.37% | 54.16% |
| 35 | 1 | 60 | 254,477 | 15.0% | 1,632,883 | 0 | 1.35% | 55.50% |
| 36 | 1 | 61 | | | 1,625,883 | 141,247 | | |
| 37 | 2 | 62 | | | 1,618,252 | 141,247 | | |
| 38 | 3 | 63 | | | 1,609,936 | 141,247 | | |
| 39 | 4 | 64 | | | 1,600,871 | 141,247 | | |
| 40 | 5 | 65 | | | 1,590,989 | 141,247 | | |
| 41 | 6 | 66 | | | 1,580,219 | 141,247 | | |
| 42 | 7 | 67 | | | 1,568,479 | 141,247 | | |
| 43 | 8 | 68 | | | 1,555,683 | 141,247 | | |
| 44 | 9 | 69 | | | 1,541,735 | 141,247 | | |
| 45 | 10 | 70 | | | 1,526,532 | 141,247 | | |
| 46 | 11 | 71 | | | 1,509,960 | 141,247 | | |
| 47 | 12 | 72 | | | 1,491,897 | 141,247 | | |
| 48 | 13 | 73 | | | 1,472,208 | 141,247 | | |
| 49 | 14 | 74 | | | 1,450,748 | 141,247 | | |
| 50 | 15 | 75 | | | 1,427,356 | 141,247 | | |
| 51 | 16 | 76 | | | 1,401,858 | 141,247 | | |
| 52 | 17 | 77 | | | 1,374,066 | 141,247 | | |
| 53 | 18 | 78 | | | 1,343,773 | 141,247 | | |
| 54 | 19 | 79 | | | 1,310,753 | 141,247 | | |
| 55 | 20 | 80 | | | 1,274,761 | 141,247 | | |
| 56 | 21 | 81 | | | 1,235,530 | 141,247 | | |
| 57 | 22 | 82 | | | 1,192,768 | 141,247 | | |
| 58 | 23 | 83 | | | 1,146,158 | 141,247 | | |
| 59 | 24 | 84 | | | 1,095,353 | 141,247 | | |
| 60 | 25 | 85 | | | 1,039,975 | 141,247 | | |
| 61 | 26 | 86 | | | 979,613 | 141,247 | | |
| 62 | 27 | 87 | | | 913,819 | 141,247 | | |
| 63 | 28 | 88 | | | 842,103 | 141,247 | | |
| 64 | 29 | 89 | | | 763,933 | 141,247 | | |
| 65 | 30 | 90 | | | 678,728 | 141,247 | | |
| 66 | 31 | 91 | | | 585,854 | 141,247 | | |
| 67 | 32 | 92 | | | 484,621 | 141,247 | | |
| 68 | 33 | 93 | | | 374,278 | 141,247 | | |
| 69 | 34 | 94 | | | 254,003 | 141,247 | | |
| 70 | 35 | 95 | | | 122,904 | 141,247 | | |
| 71 | 36 | 96 | | | (19,994) | 141,247 | | |
| 72 | 37 | 97 | | | (175,753) | 141,247 | | |
| 73 | 38 | 98 | | | (345,530) | 141,247 | | |
| 74 | 39 | 99 | | | (530,587) | 141,247 | | |
| 75 | 40 | 100 | | | (732,299) | 141,247 | | |
| 76 | 41 | 101 | | | (952,166) | 141,247 | | |
| 77 | 42 | 102 | | | (1,191,820) | 141,247 | | |
| 78 | 43 | 103 | | | (1,453,043) | 141,247 | | |
| 79 | 44 | 104 | | | (1,737,777) | 141,247 | | |
| 80 | 45 | 105 | | | (2,048,136) | 141,247 | | |
| 81 | 46 | 106 | | | (2,386,428) | 141,247 | | |
| 82 | 47 | 107 | | | (2,755,166) | 141,247 | | |
| 83 | 48 | 108 | | | (3,157,090) | 141,247 | | |
| 84 | 49 | 109 | | | (3,595,188) | 141,247 | | |
| 85 | 50 | 110 | | | (4,072,714) | 141,247 | | |

### EXAMPLE 3

In this example, we will look at the account holder who started at age 30 earning $48,000 per year and contributed 10% of compensation for the first 15 years and then stopped all contributions and retired at age 62. He is now at age 46, not willing to save another penny as he just found out he is about to receive a huge inheritance and is earning $88,000 per year and wants to know what his expected retirement benefit will be in dollars per year.

A: First, calculate the information of concern to the participant.

1) Calculate the wage inflation rate from his initial to current compensation, and choose a compensation inflation equation for his remaining working years, a guaranteed investment rate and a life expectancy after age 65.

Compensation inflation: 5.1%; Standard equation; Original compensation inflation projection was based upon 5.1% of the client. But his wage history has been at the 4.1% rate. Guaranteed investment rate: 7.0%; Expected investment rate: 9.0%; Life expectancy: 20.2738 because he is retiring 3 years earlier.

2) Obtain his vested or guaranteed Retirement Benefit based upon his initial 8% compensation deferral for the first 15 years, then calculate his remaining retirement benefit at 15% deferral level using Equation 15 supra. This shows the account holder his expected compensation replacement ratio at retirement but is not guaranteed.

Vested Retirement Income Replacement: 26.69% of final compensation after 15 years contributions at 10% of compensation. This 26.69% is Guaranteed. If from the 16th year onward, contributions fall to zero then the client may expect final compensation replacement only at this level 26.69% of final compensation.

3) Tabulate the client's Annual Vested Benefit (Equation 13) from the first year in the account until year 15. Then calculate these out until age 60. These are the single year guarantees BUT the remaining guarantees are not active until receipt of the remaining contributions.

The Annual Vested Benefit becomes zero when contributions cease.

B: Now we will look at the feasibility of the account by examining the final account balance based upon some realistic investment return (greater than the guaranteed investment rate) and a compensation inflation rate that might be expected based upon the client's occupation. This is of concern to the guarantor and is the liability of the account.

1) Calculate the final account for the account holder using Equation 7 supra with these expected investment return and compensation inflation rates.

This is $878,121 at age 62. Currently, at age 45 the account balance is already $202,910 which is vested.

2) Calculate the retirement age final compensation using this compensation inflation rate with the same compensation equation used in step A above.

Age 62 compensation is $174,913.

3) Multiply the Retirement Benefit (compensation replacement ratio) obtained from step A times their final compensation to calculate “Y” from Equations 16a-d supra. This is the account holder's expected annuity payment.

Multiply 26.69% times $174,913 and arrive at $46,680 per year is the retirement payment.

4) Substitute the final retirement account balance, and annuity Y just calculated in Equation 16 of the white paper for all years “z”. In so doing one will have the account balance supporting the cash flows “Y” for the lifetime of the account holder. From here the liability can be looked at depending upon how the actuary wants to deal with it, either carrying Y withdrawals out to the account holder's life expectancy or by multiplying Y times the probability of living each and every year out to where it's zero (age 110 for instance)

The money will last forever since withdrawals begin at ($46,680 divided by $878,121) 5.32% of the account balance, while the expected investment return is at 9%.

EXAMPLE 3

| | Age 30 | Age 45 | |
|---|---|---|---|
| Compensation | $48,000 | $88,000 | |
| Projected Retirement | $273,739 | $174,913 | |
| Age Compensation | | | |
| Age Retirement | 66 | 63 | |
| Benefits Begin | | | |
| Life Expectancy After | 17.2738 | 20.2738 | |
| Retirement | | | |
| Account Balance at | | $878,121 | |
| Retirement | | | |
| Guaranteed Return | 7.0% | 7.0% | |
| Investment | 9.0% | 9.0% | |
| Return | | | |
| Compensation | 5.1% | 4.1% | Actual |
| Inflation Rate | | | Comp. |
| | | | Inflation |
| Projected | 50.90% | 26.69% | |
| Compensation | | | |
| Replacement Ratio | | | |
| Vested Retirement | 0.0% | 26.69% | |
| Benefit | | | |
| How Long the Money | Forever | Forever | |
| Will Last | | | |

| | Years | | | | | | | Guaranteed |
|---|---|---|---|---|---|---|---|---|
| | Retirement | | | | | | Annual | or Vested |
| | Benefits | | | Deferral | Account | Benefit | Vested | Retirement |
| Year | Begin | Age | Compens. | Percentage | Balance | Payout | Benefit | Benefit |
| 0 | 36 | 30 | 48,000 | 10.0% | 4,800 | 0 | 1.90% | 1.90% |
| 1 | 35 | 31 | 49,979 | 10.0% | 10,230 | 0 | 1.87% | 3.77% |
| 2 | 34 | 32 | 52,040 | 10.0% | 16,355 | 0 | 1.83% | 5.60% |
| 3 | 33 | 33 | 54,186 | 10.0% | 23,245 | 0 | 1.80% | 7.41% |
| 4 | 32 | 34 | 56,421 | 10.0% | 30,979 | 0 | 1.77% | 9.18% |
| 5 | 31 | 35 | 58,747 | 10.0% | 39,642 | 0 | 1.74% | 10.91% |
| 6 | 30 | 36 | 61,170 | 10.0% | 49,327 | 0 | 1.71% | 12.62% |
| 7 | 29 | 37 | 63,692 | 10.0% | 60,136 | 0 | 1.68% | 14.30% |
| 8 | 28 | 38 | 66,319 | 10.0% | 72,180 | 0 | 1.65% | 15.95% |
| 9 | 27 | 39 | 69,054 | 10.0% | 85,581 | 0 | 1.62% | 17.56% |
| 10 | 26 | 40 | 71,901 | 10.0% | 100,474 | 0 | 1.59% | 19.15% |
| 11 | 25 | 41 | 74,866 | 10.0% | 117,003 | 0 | 1.56% | 20.71% |
| 12 | 24 | 42 | 77,953 | 10.0% | 135,329 | 0 | 1.53% | 22.25% |
| 13 | 23 | 43 | 81,168 | 10.0% | 155,625 | 0 | 1.51% | 23.75% |
| 14 | 22 | 44 | 84,515 | 10.0% | 178,083 | 0 | 1.48% | 25.23% |
| 15 | 21 | 45 | 88,000 | 10.0% | 202,910 | 0 | 1.45% | 26.69% |
| 16 | 17 | 46 | 91,629 | 0.0% | 221,172 | 0 | 0.00% | 26.69% |
| 17 | 16 | 47 | 95,407 | 0.0% | 241,078 | 0 | 0.00% | 26.69% |
| 18 | 15 | 48 | 99,342 | 0.0% | 262,775 | 0 | 0.00% | 26.69% |
| 19 | 14 | 49 | 103,438 | 0.0% | 286,424 | 0 | 0.00% | 26.69% |
| 20 | 13 | 50 | 107,704 | 0.0% | 312,202 | 0 | 0.00% | 26.69% |
| 21 | 12 | 51 | 112,145 | 0.0% | 340,301 | 0 | 0.00% | 26.69% |
| 22 | 11 | 52 | 116,769 | 0.0% | 370,928 | 0 | 0.00% | 26.69% |
| 23 | 10 | 53 | 121,584 | 0.0% | 404,311 | 0 | 0.00% | 26.69% |
| 24 | 9 | 54 | 126,598 | 0,0% | 440,699 | 0 | 0.00% | 26.69% |
| 25 | 8 | 55 | 131,819 | 0.0% | 480,362 | 0 | 0.00% | 26.69% |
| 26 | 7 | 56 | 137,254 | 0.0% | 523,595 | 0 | 0.00% | 26.69% |
| 27 | 6 | 57 | 142,914 | 0.0% | 570,718 | 0 | 0.00% | 26.69% |
| 28 | 5 | 58 | 148,808 | 0.0% | 622,083 | 0 | 0.00% | 26.69% |
| 29 | 4 | 59 | 154,944 | 0,0% | 678,070 | 0 | 0.00% | 26.69% |
| 30 | 3 | 60 | 161,333 | 0.0% | 739,097 | 0 | 0.00% | 26.69% |
| 31 | 2 | 61 | 167,986 | 0.0% | 805,615 | 0 | 0.00% | 26.69% |
| 32 | 1 | 62 | 174,913 | 0.0% | 878,121 | 0 | 0.00% | 26.69% |
| 33 | 1 | 63 | | | 906,270 | 46,680 | | |
| 34 | 2 | 64 | | | 936,953 | 46,680 | | |
| 35 | 3 | 65 | | | 970,397 | 46,680 | | |
| 36 | 4 | 66 | | | 1,006,852 | 46,680 | | |
| 37 | 5 | 67 | | | 1,046,587 | 46,680 | | |
| 38 | 6 | 68 | | | 1,089,899 | 46,680 | | |
| 39 | 7 | 69 | | | 1,137,108 | 46,680 | | |
| 40 | 8 | 70 | | | 1,188,566 | 46,680 | | |
| 41 | 9 | 71 | | | 1,244,656 | 46,680 | | |
| 42 | 10 | 72 | | | 1,305,794 | 46,680 | | |
| 43 | 11 | 73 | | | 1,372,434 | 46,680 | | |
| 44 | 12 | 74 | | | 1,445,072 | 46,680 | | |
| 45 | 13 | 75 | | | 1,524,247 | 46,680 | | |
| 46 | 14 | 76 | | | 1,610,547 | 46,680 | | |
| 47 | 15 | 77 | | | 1,704,615 | 46,680 | | |
| 48 | 16 | 78 | | | 1,807,149 | 46,680 | | |
| 49 | 17 | 79 | | | 1,918,911 | 46,680 | | |
| 50 | 18 | 80 | | | 2,040,732 | 46,680 | | |
| 51 | 19 | 81 | | | 2,173,516 | 46,680 | | |
| 52 | 20 | 82 | | | 2,318,252 | 46,680 | | |
| 53 | 21 | 83 | | | 2,476,013 | 46,680 | | |
| 54 | 22 | 84 | | | 2,647,973 | 46,680 | | |
| 55 | 23 | 85 | | | 2,835,409 | 46,680 | | |
| 56 | 24 | 86 | | | 3,039,714 | 46,680 | | |
| 57 | 25 | 87 | | | 3,262,407 | 46,680 | | |
| 58 | 26 | 88 | | | 3,505,142 | 46,680 | | |
| 59 | 27 | 89 | | | 3,769,724 | 46,680 | | |
| 60 | 28 | 90 | | | 4,058,118 | 46,680 | | |
| 61 | 29 | 91 | | | 4,372,467 | 46,680 | | |
| 62 | 30 | 92 | | | 4,715,107 | 46,680 | | |
| 63 | 31 | 93 | | | 5,088,586 | 46,680 | | |
| 64 | 32 | 94 | | | 5,495,677 | 46,680 | | |
| 65 | 33 | 95 | | | 5,939,407 | 46,680 | | |
| 66 | 34 | 96 | | | 6,423,072 | 46,680 | | |
| 67 | 35 | 97 | | | 6,950,267 | 46,680 | | |
| 68 | 36 | 98 | | | 7,524,910 | 46,680 | | |
| 69 | 37 | 99 | | | 8,151,270 | 46,680 | | |
| 70 | 38 | 100 | | | 8,834,003 | 46,680 | | |
| 71 | 39 | 101 | | | 9,578,182 | 46,680 | | |
| 72 | 40 | 102 | | | 10,389,337 | 46,680 | | |
| 73 | 41 | 103 | | | 11,273,496 | 46,680 | | |
| 74 | 42 | 104 | | | 12,237,229 | 46,680 | | |
| 75 | 43 | 105 | | | 13,287,698 | 46,680 | | |
| 76 | 44 | 106 | | | 14,432,710 | 46,680 | | |
| 77 | 45 | 107 | | | 15,680,772 | 46,680 | | |
| 78 | 46 | 108 | | | 17,041,160 | 46,680 | | |
| 79 | 47 | 109 | | | 18,523,983 | 46,680 | | |
| 80 | 48 | 110 | | | 20,140,260 | 46,680 | | |

### EXAMPLE 4

In this last example, we will look at the account holder who begins at age 42 and wants to roll over $100,000 into his account from his previous employer's plan. He earns $53,000 at this new position and will save about 5% of his compensation until retirement at age 65. He wants to know what his final compensation replacement will be at that time.

A: First, calculate the information of concern to the account holder.

1) Assume a compensation inflation rate and compensation equation, guaranteed investment return and life expectancy.

Compensation inflation: 5.5%; Standard equation; His compensation are expected to increase at 7.0% per annum. Guaranteed investment rate: 7.0%; Expected investment rate: 9.0%; Life expectancy: 17.274 beyond age 65, interpolated from 83 GAM tables.

2) Obtain his vested or guaranteed Retirement Benefit based upon his initial $100,000 roll over and 5% compensation deferral then calculate his remaining retirement benefit at 5% deferral level using Equation 15 supra. This shows the account holder his expected compensation replacement ratio at retirement but is not guaranteed.

He will defer 193.7% of his compensation this year, $100,000/$53,000 plus 5% of $53,000 to give a retirement benefit of 27.22% after the first year. This is his guaranteed benefit after the first year's contribution.

3) Tabulate the client's Annual Vested Benefit (Equation 13) from the first year in the plan until age 65. These are the single year guarantees BUT the remaining guarantees are not active until receipt of the remaining contributions.

The sum of the annual vested benefits is 40.92% of his final compensation at his retirement.

B: Now we will look at the feasibility of the account by examining the final account balance based upon some realistic investment return (greater than the guaranteed investment rate) and a wage inflation rate that might be expected based upon the account holder's occupation. This is of concern to the guarantor and is the liability of the account.

1) Calculate the final account for the account holder using Equation 7 supra with these expected investment return and compensation inflation rates.

This is $1,101,917 at age 65. Currently, at age 42 the account balance is $102,650 after the $100,000 roll over and 5% compensation contribution which are vested.

2) Calculate the retirement age final compensation using this compensation inflation rate with the same compensation equation used in step A above.

Age 65 compensation is $251,248.

3) Multiply the Retirement Benefit (compensation replacement ratio) obtained from step A times their final compensation to calculate “Y” from Equations 16a-d supra. This is the account holder's expected annuity payment.

Multiply 40.92% times $251,248 and arrive at $102,806 per year is the retirement payment.

4) Substitute the final retirement account balance, and annuity Y just calculated in Equations 16a-d for all years “z”. In so doing one will have the account balance supporting the cash flows “Y” for the lifetime of the account holder. From here the liability can be looked at depending upon how the actuary wants to deal with it, either carrying Y withdrawals out to the account holder's life expectancy or by multiplying Y times the probability of living each and every year out to where it's zero (age 110 for instance)

The money will last 25.1 years after retirement since withdrawals begin at ($102,806 divided by $1,101,917) 9.33% of the account balance, while the expected investment return is only 9%.

EXAMPLE 4

| | Age 42 | |
|---|---|---|
| Compensation | $53,000 | |
| Projected Retirement Age | $251,248 | |
| Compensation | | |
| Age Retirement Benefits | 66 | |
| Begin | | |
| Life Expectancy After | 17.274 | |
| Retirement | | |
| Account Balance at | $1,101,917 | |
| Retirement | | |
| Guaranteed Return | 7.0% | |
| Expected Investment | 9.0% | |
| Return | | |
| Compens. Inflation Rate | 5.5% | Actual 7.0% |
| Projected Compens. | 40.92% | |
| Replacement Ratio | | |
| Vested Retirement Benefit | 27.22% | |
| How Long the Money Will | 25.10 | Years after retirement |
| Last | | |

| | Years | | | | | | | Guaranteed |
|---|---|---|---|---|---|---|---|---|
| | Retirement | | | | | | Annual | or Vested |
| | Benefits | | | Deferral | Account | Benefit | Vested | Retirement |
| Year | Begin | Age | Compens. | Percentage | Balance | Payout | Benefit | Benefit |
| 0 | 24 | 42 | 53,000 | 193.7% | 102,650 | 0 | 27.22% | 27.22% |
| 1 | 23 | 43 | 56,710 | 5.0% | 114,724 | 0 | 0.69% | 27.91% |
| 2 | 22 | 44 | 60,680 | 5.0% | 128,083 | 0 | 0.68% | 28.59% |
| 3 | 21 | 45 | 64,927 | 5.0% | 142,857 | 0 | 0.67% | 29.27% |
| 4 | 20 | 46 | 69,472 | 5.0% | 159,188 | 0 | 0.66% | 29.93% |
| 5 | 19 | 47 | 74,335 | 5.0% | 177,231 | 0 | 0.65% | 30.58% |
| 6 | 18 | 48 | 79,539 | 5.0% | 197,159 | 0 | 0.65% | 31.23% |
| 7 | 17 | 49 | 85,106 | 5.0% | 219,159 | 0 | 0.64% | 31.87% |
| 8 | 16 | 50 | 91,064 | 5.0% | 243,436 | 0 | 0.63% | 32.49% |
| 9 | 15 | 51 | 97,438 | 5.0% | 270,217 | 0 | 0.62% | 33.11% |
| 10 | 14 | 52 | 104,259 | 5.0% | 299,750 | 0 | 0.61% | 33.72% |
| 11 | 13 | 53 | 111,557 | 5.0% | 332,305 | 0 | 0.60% | 34.32% |
| 12 | 12 | 54 | 119,366 | 5.0% | 368,181 | 0 | 0.59% | 34.92% |
| 13 | 11 | 55 | 127,722 | 5.0% | 407,704 | 0 | 0.58% | 35.50% |
| 14 | 10 | 56 | 136,662 | 5.0% | 451,230 | 0 | 0.58% | 36.08% |
| 15 | 9 | 57 | 146,229 | 5.0% | 499,152 | 0 | 0.57% | 36.65% |
| 16 | 8 | 58 | 156,465 | 5.0% | 551,899 | 0 | 0.56% | 37.21% |
| 17 | 7 | 59 | 167,417 | 5.0% | 609,941 | 0 | 0.55% | 37.76% |
| 18 | 6 | 60 | 179,136 | 5.0% | 673,792 | 0 | 0.54% | 38.31% |
| 19 | 5 | 61 | 191,676 | 5.0% | 744,017 | 0 | 0.54% | 38.84% |
| 20 | 4 | 62 | 205,093 | 5.0% | 821,234 | 0 | 0.53% | 39.37% |
| 21 | 3 | 63 | 219,450 | 5.0% | 906,117 | 0 | 0.52% | 39.90% |
| 22 | 2 | 64 | 234,811 | 5.0% | 999,408 | 0 | 0.52% | 40.41% |
| 23 | 1 | 65 | 251,248 | 5.0% | 1,101,917 | 0 | 0.51% | 40.92% |
| 24 | 1 | 66 | | | 1,089,032 | 102,806 | | |
| 25 | 2 | 67 | | | 1,074,986 | 102,806 | | |
| 26 | 3 | 68 | | | 1,059,677 | 102,806 | | |
| 27 | 4 | 69 | | | 1,042,989 | 102,806 | | |
| 28 | 5 | 70 | | | 1,024,800 | 102,806 | | |
| 29 | 6 | 71 | | | 1,004,974 | 102,806 | | |
| 30 | 7 | 72 | | | 983,363 | 102,806 | | |
| 31 | 8 | 73 | | | 959,807 | 102,806 | | |
| 32 | 9 | 74 | | | 934,132 | 102,806 | | |
| 33 | 10 | 75 | | | 906,145 | 102,806 | | |
| 34 | 11 | 76 | | | 875,640 | 102,806 | | |
| 35 | 12 | 77 | | | 842,389 | 102,806 | | |
| 36 | 13 | 78 | | | 806,146 | 102,806 | | |
| 37 | 14 | 79 | | | 766,641 | 102,806 | | |
| 38 | 15 | 80 | | | 723,580 | 102,806 | | |
| 39 | 16 | 81 | | | 676,644 | 102,806 | | |
| 40 | 17 | 82 | | | 625,484 | 102,806 | | |
| 41 | 18 | 83 | | | 569,719 | 102,806 | | |
| 42 | 19 | 84 | | | 508,935 | 102,806 | | |
| 43 | 20 | 85 | | | 442,681 | 102,806 | | |
| 44 | 21 | 86 | | | 370,464 | 102,806 | | |
| 45 | 22 | 87 | | | 291,748 | 102,806 | | |
| 46 | 23 | 88 | | | 205,946 | 102,806 | | |
| 47 | 24 | 89 | | | 112,423 | 102,806 | | |
| 48 | 25 | 90 | | | 10,483 | 102,806 | | |
| 49 | 26 | 91 | | | (100,632) | 102,806 | | |
| 50 | 27 | 92 | | | (221,747) | 102,806 | | |
| 51 | 28 | 93 | | | (353,762) | 102,806 | | |
| 52 | 29 | 94 | | | (497,659) | 102,806 | | |
| 53 | 30 | 95 | | | (654,507) | 102,806 | | |
| 54 | 31 | 96 | | | (825,471) | 102,806 | | |
| 55 | 32 | 97 | | | (1,011,822) | 102,806 | | |
| 56 | 33 | 98 | | | (1,214,944) | 102,806 | | |
| 57 | 34 | 99 | | | (1,436,347) | 102,806 | | |
| 58 | 35 | 100 | | | (1,677,677) | 102,806 | | |
| 59 | 36 | 101 | | | (1,940,726) | 102,806 | | |
| 60 | 37 | 102 | | | (2,227,449) | 102,806 | | |
| 61 | 38 | 103 | | | (2,539,978) | 102,806 | | |
| 62 | 39 | 104 | | | (2,880,634) | 102,806 | | |
| 63 | 40 | 105 | | | (3,251,950) | 102,806 | | |
| 64 | 41 | 106 | | | (3,656,684) | 102,806 | | |
| 65 | 42 | 107 | | | (4,097,843) | 102,806 | | |
| 66 | 43 | 108 | | | (4,578,708) | 102,806 | | |
| 67 | 44 | 109 | | | (5,102,850) | 102,806 | | |
| 68 | 45 | 110 | | | (5,674,165) | 102,806 | | |

Thus, it is seen that the objects of the invention are efficiently attained, although modifications to the invention may be readily apparent to those having ordinary skill in the art, and these obvious modifications are intended to be within the spirit and scope of the invention as embodied in the following claims.

What we claim is:

1. A system for administering a guaranteed benefit account held by an individual, comprising:
a computer including a central processing unit for processing data;
storage means for storing input data related to compensation levels of said individual account holder, contribution patterns of said individual account holder, and time periods from opening of said account until disbursement of account funds for said individual account holder; and,
a first arithmetic logic circuit configured to calculate account disbursements as a guaranteed percentage of individual account holder compensation levels.

2. A system for administering a guaranteed benefit account held by an individual as recited in claim 1 wherein said account is non-sponsored.

3. A system for administering a guaranteed benefit account held by an individual as recited in claim 1 wherein said account is a component of a plan.

4. A system for administering a guaranteed benefit account held by an individual as recited in claim 1 wherein said account is an optional component of a plan.

5. A system for administering a guaranteed benefit plan sponsored by a first entity, comprising:
a computer including a central processing unit for processing data;
storage means for storing input data related to compensation levels of plan participants, contribution patterns of plan participants, and time periods from entry into said plan until disbursement of funds for each plan participant; and,
a first arithmetic logic circuit configured to calculate plan disbursements as a guaranteed percentage of individual plan participant compensation levels, where said guarantee is made by a second entity.

6. A system for administering a guaranteed benefit plan as recited in claim 5 wherein said individual plan participant compensation levels are measured proximate time of disbursement of funds to said individual plan participants.

7. A system for administering a guaranteed benefit plan as recited in claim 5 wherein said second entity is not a government entity or agency.

8. A system for administering a guaranteed benefit plan as recited in claim 5, further comprising a second arithmetic logic circuit configured to calculate plan assets and liabilities based upon said input data and certain assumptions of compensation inflation, investment return and life expectancy for plan participants.

9. A system for administering a guaranteed benefit plan as recited in claim 6 wherein said certain assumptions are user-definable.
